(19) United States
(12) Patent Application Publication
(10) Pub. No.: US 2008/0192301 A1
(43) Pub. Date: Aug. 14, 2008

(54) IMAGE READING APPARATUS

(75) Inventors: Ryo OGASAHARA, Fukuoka (JP); Kenichi UEMURA, Fukuoka (JP); Yasunori NOZAKI, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/025,114

(22) Filed: Feb. 4, 2008

(30) Foreign Application Priority Data
Feb. 9, 2007 (JP) P2007-030020

(51) Int. Cl. H04N 1/04; H04N 1/047

(52) U.S. Cl. 358/401; 358/498

(57) ABSTRACT

An image reading apparatus includes a roller which transports a sheet, a motor which drives the roller, an image sensor which reads data from the sheet and a control unit which synchronizes a read timing of the image sensor with a drive timing of the motor in response to change in the drive timing of the motor. Accordingly, when transporting an sheet is temporarily stopped, the transport speed can be changed as desired, whereby the shock caused by changing the transport speed is more lightened and if the resolution to read the original is high, a discrepancy in the data read by the image sensor caused by temporary stop of transporting the sheet can be also suppressed.

### BACKGROUND

This invention relates to an image reading apparatus for transporting a sheet and reading the sheet by an image sensor.

Hitherto, for this kind of image reading apparatus to transport a sheet and read the sheet by an image sensor, data read by the image sensor is stored in a memory, but it is necessary to stop transporting the sheet and interrupt reading the sheet because a capacity of the memory becomes full of the data depending on the data transfer condition, etc.

However, if transporting of the sheet is stopped suddenly, a mechanical shock occurs as the sheet transport speed is higher, and for a sheet shown in FIG. 9A, the data in a B portion read when the image sensor is stopped cannot precisely be read as shown in FIG. 9B. Thus, a discrepancy occurs in the read data, and the larger the shock, the larger is the discrepancy in the read data.

Thus, to stop a transport operation of the sheet, the transport operation is stopped while the transport speed is decreased stepwise; to restart the transport operation, the transport speed is increased stepwise to the reference transport speed; thereby suppressing the shock caused by stopping the transport operation.

FIG. 10 shows an example of read by an image sensor when the transport speed of the sheet is decreased stepwise. In FIG. 10, (a) shows a drive pattern of a motor for changing transport speed, (b) shows a read pattern of the image sensor, and (c) shows read data of the image sensor.

The read timing intervals of the image sensor are constant and the image sensor reads the transported sheet in accordance with the read timing.

As shown in FIG. 10(a), to stop transporting the sheet, the transport speed is decreased stepwise in such a manner that the motor drive timing interval becomes an integral multiple of the read timing interval of the image sensor.

At this time, if the transport speed decreases, namely, if the motor drive timing interval is widened, the image sensor for reading at constant intervals reads the same portion of the sheet redundantly and thus the redundant portions (X₁, X₂, X₃, and X₄) are discarded. (For example, refer to Patent document 1.)

[Patent document 1] JP-A-7-131593

However, in the method of the related art described above, the motor drive timing is determined based on read timing of the image sensor for reading at constant intervals and therefore the transport speed of the sheet can be changed only stepwise.

Thus, if the resolution to read the sheet is high, a discrepancy occurs still in the read data due to a shock occurring when the transport speed is changed because the transport speed can be changed only stepwise.

### SUMMARY

It is therefore an object of the invention to make it possible to change the transport speed as desired when transporting a sheet is temporarily stopped, more lighten shock caused by changing the transport speed, and suppress a discrepancy in data read by an image sensor caused by temporary stop of transporting the sheet even if the resolution to read the sheet is high.

To solve the above-described problems, according to the invention, there is provided an image reading apparatus including a roller which transports a sheet, a motor which drives the roller, an image sensor which reads data from the sheet and a control unit which synchronizes a read timing of the image sensor with a drive timing of the motor in response to change in the drive timing of the motor.

Accordingly, when transporting the sheet is temporarily stopped, the transport speed can be changed as desired, the shock caused by changing the transport speed is more lightened, and if the resolution to read the sheet is high, a discrepancy in the data read by the image sensor caused by temporary stop of transporting the sheet can also suppressed.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a sectional view of an image reading apparatus in a first embodiment of the invention;

FIG. 2 is a circuit diagram of the image reading apparatus in the first embodiment of the invention;

FIG. 3 is a conceptual drawing of read in the first embodiment of the invention;

FIG. 4A and 4B are schematic representations of the image reading apparatus in the first embodiment of the invention;

FIG. 5 is a flowchart of the image reading apparatus in the first embodiment of the invention;

FIG. 6 is a circuit diagram of an image reading apparatus in a second embodiment of the invention;

FIG. 7 is a flowchart of the image reading apparatus in the second embodiment of the invention;

FIG. 8 is a perspective view of a copier including the image reading apparatus in the embodiments of the invention;

FIG. 9A and 9B are schematic representations of an image reading apparatus in a related art; and

FIG. 10 is a conceptual drawing of read of an image reading apparatus in a related art.

### DETAILED DESCRIPTION

Referring now to the accompanying drawings, there are shown embodiments of the invention.

### First Embodiment

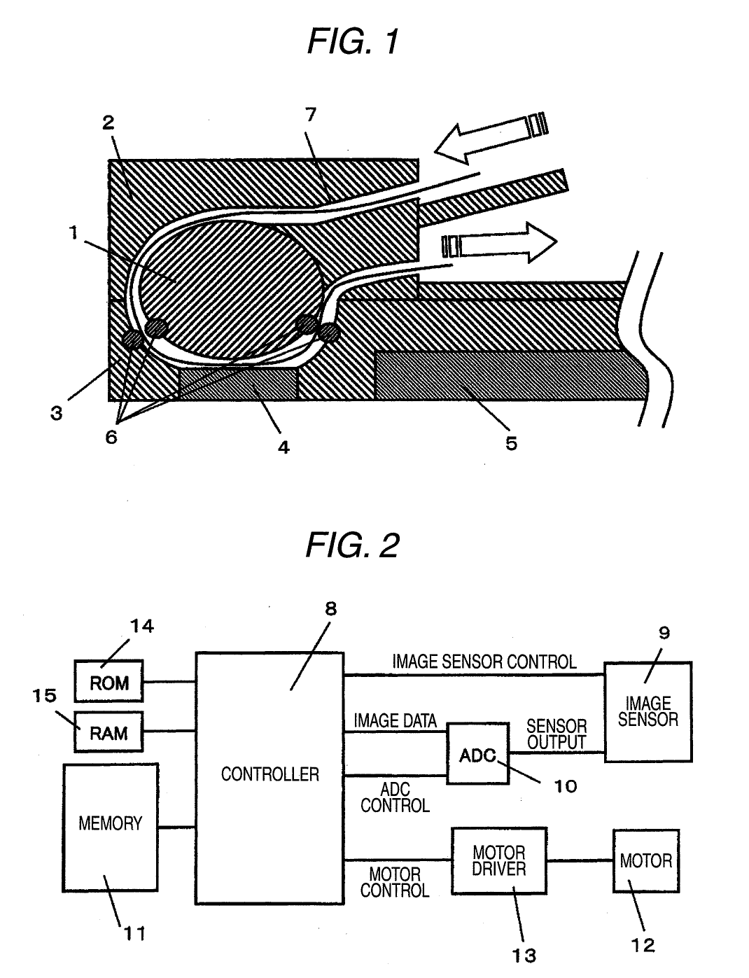

In FIG. 1, an automatic feeder 2 including a guide 1 for transporting a sheet is provided in a main unit 3. The main unit 3 has a sheet read plane 4 made of glass, etc., for allowing light for reading the transported original to pass through, and a sheet placement plane 5, etc.

The sheet read plane 4 is a portion for reading the sheet transported from the automatic feeder 2 and the sheet placement plane 5 is a portion for reading the sheet from a sheet bed without using the automatic feeder 2.

The image reading apparatus contains a plurality of pairs of rollers 6 including a motor which has power for transporting the sheet and a transport path 7 for transporting the sheet.

In FIG. 2, connected to a controller 8 for controlling the image reading apparatus are an image sensor 9, an ADC (Analog to Digital Converter) 10 for converting analog data read by the image sensor 9 into digital data, a memory 11 for storing the digital data, a motor driver 13 for controlling a motor 12 of a stepping motor, etc., ROM 14, RAM 15, and the like.

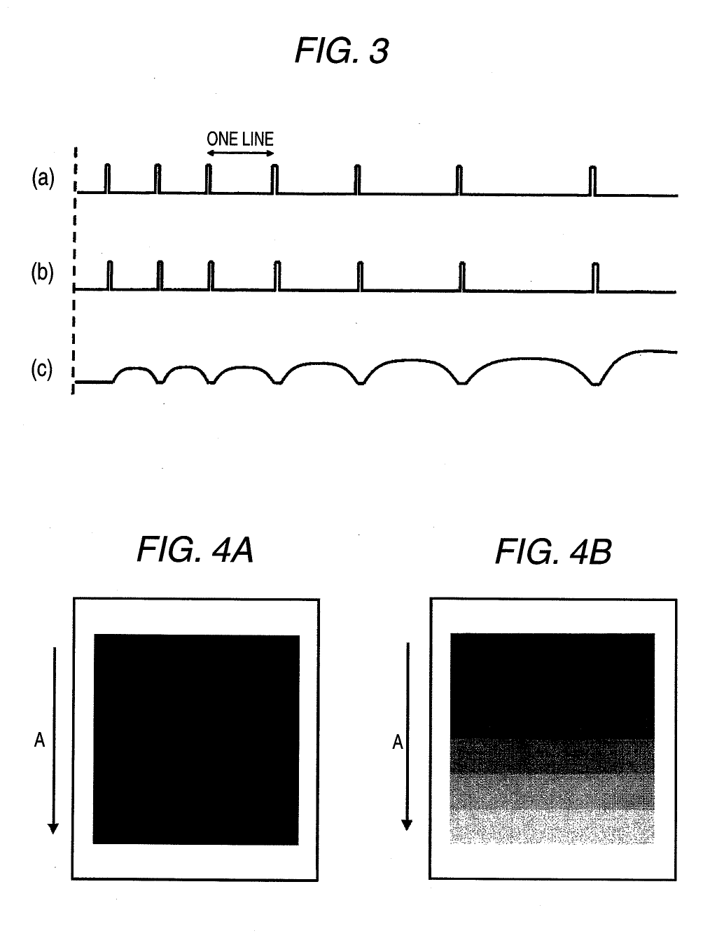

FIG. 3 is a conceptual drawing to show an example of a motor drive pattern for stopping transporting the sheet and a signal level of read of the image sensor 9 at the time in the described image reading apparatus in the above-configured image reading apparatus.

In FIG. 3, (a) shows a drive pattern of the motor 12 for decreasing transport speed, (b) shows a read pattern of the image sensor, and (c) shows read data of the image sensor.

The drive pattern of the motor 12 can be set as desired and the transport speed of the sheet is changed as desired.

The read pattern of the image sensor 9 is synchronized with the drive pattern of the motor 12 and the transported sheet is read by the image sensor 9.

Accordingly, to stop transporting the sheet, the transport speed can be changed as desired, whereby the shock caused by changing the transport speed is lightened and smooth transport stopping is accomplished. Thus, if the resolution to read the sheet is high, a discrepancy in the read data of the image sensor 9 caused by stopping transporting the sheet can also be suppressed.

To restart transporting the sheet, the read timing of the image sensor 9 is synchronized with the drive timing of the motor 12 and thus the shock caused by changing the transport speed is lightened and smooth transport restarting can be accomplished.

Accordingly, if the resolution to read the sheet is high, a discrepancy in the read data of the image sensor 9 caused by restarting transporting the sheet can also be suppressed.

In the invention, to temporarily stop transporting the sheet, a signal level of the data read by the image sensor 9 is converted in response to the transport speed so that the signal level becomes constant.

The conversion will be discussed about the case where the transport speed is decreased from the reference transport speed.

To decrease the transport speed, the drive timing interval of the motor 12 is made wider than the drive timing interval of the motor 12 at the reference transport speed for decreasing the transport speed and thus the read time per line of the image sensor 9 synchronized with the drive timing is prolonged.

Thus, if the transport speed becomes low in the image sensor 9 for exposing the sheet to light and reading the reflected light amount, the exposure time while the image sensor 9 reads one line is prolonged, the reflected light amount read by the image sensor 9 increases, and the signal level of the read data becomes large.

Therefore, if the transport speed is decreased, the signal level of the read data becomes larger as the transport speed becomes lower for the image sensor 9 for reading the transported sheet in A direction as shown in FIGS. 4A and 4B and thus in the read sheet (b), color becomes brighter in the portion where the transport speed is lower as compared with the original sheet (a) and it becomes impossible to reproduce the essential light and shade of the original sheet.

Thus, the signal level of the data read at the decreased transport speed is converted into the signal level at the reference transport speed so that the signal level of the read data becomes constant.

Accordingly, if the transport speed is decreased to stop transporting the sheet, the signal level is also made constant, whereby uniformity in density (light and shade) of the read sheet can be eliminated.

When transporting the sheet is restarted, the signal level of the read data also changes with acceleration and thus the signal level is converted so that it becomes constant.

Accordingly, if the transport speed is increased to restart transporting the sheet, the signal level is also made constant, whereby uniformity in density (light and shade) of the read original can be eliminated.

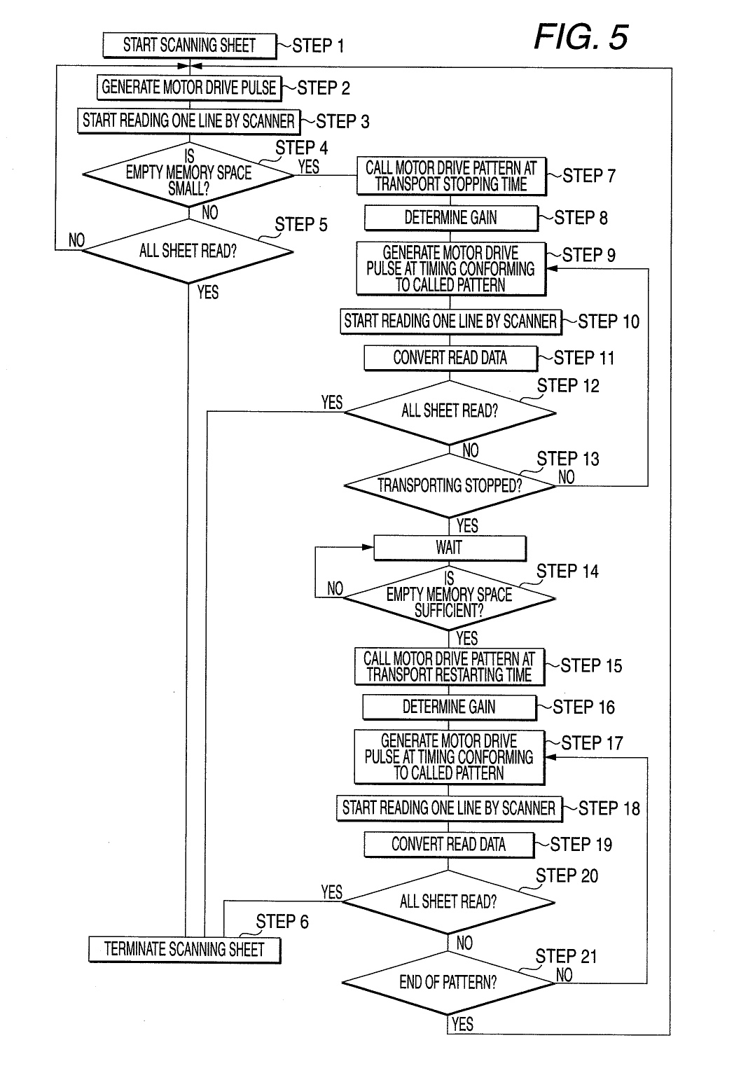

The operation sequence of the image reading apparatus in the embodiment will be discussed with reference to FIG. 5.

When a sheet is set in the automatic feeder 2 (step 1), the motor 12 controlled by the motor driver 13 is driven at a given drive timing for rotating the rollers 6 to transport the sheet at the reference speed (step 2), the transported sheet is read as analog data one line at a time by the image sensor 9 (step 3), the read analog data is converted into digital data by the ADC 10, and the digital data is stored in the memory 11 and is output to the outside through a network, etc.

A determination is made based on a preset memory capacity so that a capacity of the memory 11 does not become full of data (step 4). If the capacity of the memory 11 is exceeded the preset memory capacity, transporting the sheet is stopped.

Accordingly, a situation in which the capacity of the memory 11 becomes full of data and the read data cannot be stored can be eliminated.

If the memory 11 has an empty space, a read operation of the sheet is repeated and if it is determined that the sheet to be transported does not exist (step 5), reading the sheet is terminated (step 6).

If the capacity of the memory 11 is about to become full of data and transporting the sheet is to be stopped, a drive pattern of the motor 12 for stopping is called from the ROM 14 (step 7).

The drive pattern is a pattern for suppressing the shock at the stopping time and the drive timing interval of the motor 12 is widened for decreasing the transport speed.

To convert the signal level of the data read by the image sensor 9 according to change in the transport speed, using the transport speed based on the preset drive pattern of the motor 12, the ratio between the transport speed at the preceding line and the transport speed at the next line to be read is taken and is multiplied by a gain of the preceding line to determine the gain of the next line to be read (step 8).

Accordingly, conversion of the data read by the image sensor 9 can be executed consecutively.

Then, the rollers 6 are rotated for transporting the sheet in accordance with the drive pattern of the motor 12 at step 7 (step 9) and the image sensor 9 reads the sheet one line at a time in synchronization with the drive timing conforming to the drive pattern (step 10).

The read timing of the image sensor 9 is thus synchronized with the drive timing of the motor 12, whereby when the transport speed is decreased, the shock caused by changing the transport speed is lightened and smooth transport stopping can be accomplished.

Thus, if the resolution to read the sheet is high, a discrepancy in the read data of the image sensor 9 caused by stopping transporting the sheet can also be suppressed.

The read data is stored in the memory 11 and is multiplied by the gain calculated by the controller 8, thereby converting the signal level (step 11).

Accordingly, if the transport speed is decreased to stop transporting the sheet, the signal level is lowered to the same signal level as the reference transport speed and is made constant by multiplying the signal level by the gain, whereby uniformity in density (light and shade) of the read sheet can be eliminated.

Then, if it is determined that the sheet to be transported does not exist (step 12), reading the sheet is terminated (step 6); if reading the sheet does not terminate, the steps are repeated until the drive pattern called at step 7 terminates, and transporting the sheet is stopped (step 13).

After transporting the sheet is stopped, the process waits until the capacity of the memory 11 falls below the preset memory capacity and the memory 11 has a sufficient empty space (step 14). If there is an empty space in the memory 1 1, a drive pattern of the motor 12 at the transport restarting time is called from the ROM 14 (step 15), the gain based on the transport speed determined according to the drive pattern is calculated (step 16), the motor 12 rotates the rollers 6 in accordance with the drive pattern (step 17), and the image sensor 9 reads the transported sheet one line at a time (step 18).

The read timing of the image sensor 9 is thus synchronized with the drive timing of the motor 12, whereby when the transport speed is increased, the speed can be determined as desired and the shock caused by changing the transport speed is lightened and smooth transport restarting can be accomplished.

Thus, if the resolution to read the sheet is high, a discrepancy in the read data of the image sensor 9 caused by restarting to transport the sheet can also be suppressed.

The read data is multiplied by the gain, thereby converting the signal level (step 19).

Accordingly, if the transport speed is increased to restart transporting the sheet, the signal level is lowered to the same signal level as the reference transport speed and is made constant by multiplying the signal level by the gain, whereby uniformity in density (light and shade) of the read sheet can be eliminated.

If it is determined that the sheet to be transported does not exist during execution of the drive pattern for restarting to transport the sheet (step 20), reading the sheet is terminated (step 6). When the called drive pattern of the motor 12 terminates (step 21), the transport speed of the sheet is restored to the reference transport speed and thus the process returns to step 2 and the usual operation is performed.

Accordingly, in the embodiment, the drive timing of the motor 12 and the read timing of the image sensor 9 are synchronized with each other, whereby the transport speed can be determined as desired and the shock caused by changing the transport speed is lightened and smooth transport can be accomplished.

Thus, if the resolution to read the sheet is high, a discrepancy in the read data of the image sensor 9 caused by restarting to transport the sheet can also be suppressed.

The reference transport speed rather than the preceding gain may be used to calculate the gain.

Since the exposure time can be found from the drive pattern of the motor 12, the gain responsive to the transport speed may be previously stored.

Further, to calculate the gain from the reference transport speed, the gain is previously calculated in response to the transport speed and the calculated gain is stored in a table provided in the ROM 14, whereby if the transport speed changes, the gain corresponding to the transport speed is taken out from the table. Thus, the need for the controller 8 to calculate the gain is eliminated and the calculation load on the controller 8 can be lightened.

### Second Embodiment

In a second embodiment, data read by an image sensor 9 is converted using an amplifier. Components identical with those of the first embodiment are denoted by the same reference numerals and will not be discussed again in detail.

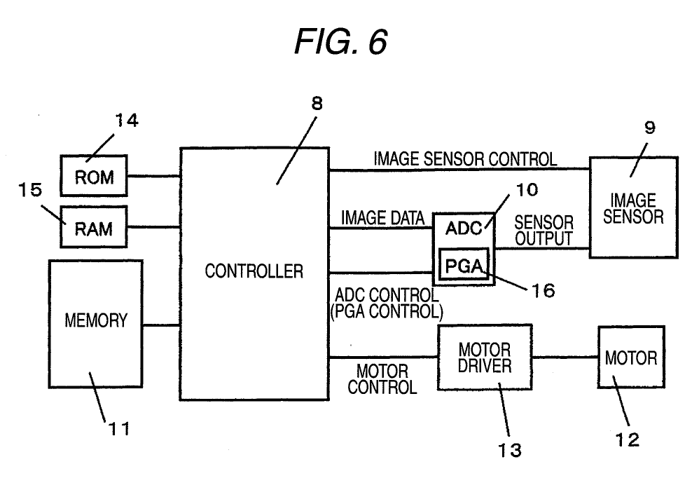

An ADC 10 has a PGA (Programmable Gain Amplifier) 16 of an amplifier to be used for AD conversion, as shown in FIG. 6.

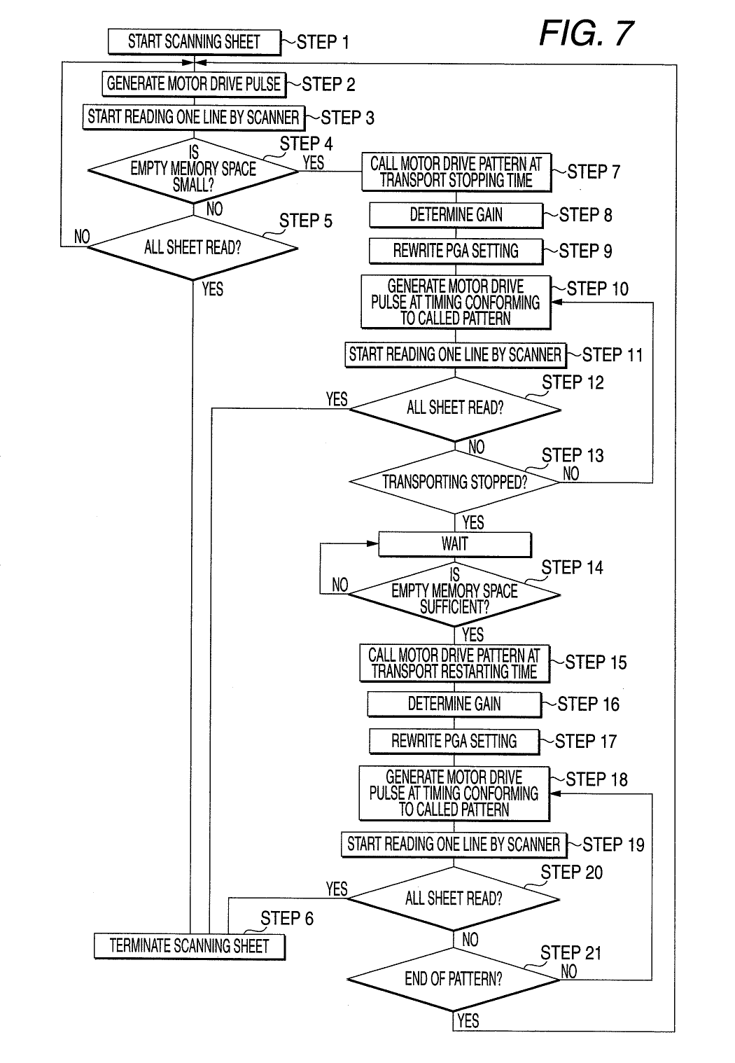

The operation of the above-configured image reading apparatus will be discussed with FIG. 7.

Usual reading is performed until a capacity of a memory 11 becomes full of data in reading a sheet (steps 1 to 6). When the capacity of the memory 11 is about to become full of data, the stop operation of transporting the sheet is performed.

To stop transporting the sheet, a drive pattern of a motor 12 at the transport stopping time is called (step 7), the gain responsive to the transport speed is taken out from a table (step 8), and the PGA 16 is set up based on the gain (step 9).

After the PGA 16 is set up (step 9), the motor 12 rotates rollers 6 for transporting the sheet in accordance with the drive pattern (step 10) and an image sensor 9 reads the sheet one line at a time in synchronization with the drive timing conforming to the drive pattern (step 11).

The read analog data is converted into digital data through the ADC 10 and at the same time, the read data is converted based on the gain set in the PGA 16 and the result is stored in the memory 11.

Then, if it is determined that the sheet to be transported does not exist (step 12), reading the sheet is terminated (step 6); if it is determined that the sheet to be transported exists, the steps are repeated until the drive pattern called at step 7 terminates, and transporting the sheet is stopped (step 13).

After transporting the sheet is stopped, the process waits until there is a sufficient empty space in the memory 11 (step 14). If there is an empty space in the memory 11, a drive pattern is called (step 15) and while the gain based on the transport speed is set in the PGA 16, the sheet is read and when the transport speed is reached to a reference transport speed, the process returns to step 2 and the usual operation is performed (steps 16 to 21).

Accordingly, in the embodiment, the drive timing of the motor 12 and the read timing of the image sensor 9 are synchronized with each other, whereby the transport speed can be determined as desired and the shock caused by changing the transport speed is lightened and smooth transport can be accomplished.

The PGA 16 contained in the ADC 10 rather than a controller 8 is used to convert the data read by the image sensor 9, whereby the read data can be converted simply as the controller 8 sets the gain in the PGA 16 in response to the transport speed, so that the calculation load on the controller 8 can be lightened.

The gain to be set in the PGA 16 may be found by calculation if the table storing the gain does not exist.

The PGA 16 is set up just before reading the sheet is started (step 11, step 19), whereby conversion of the data read by the image sensor 9 can be executed consecutively.

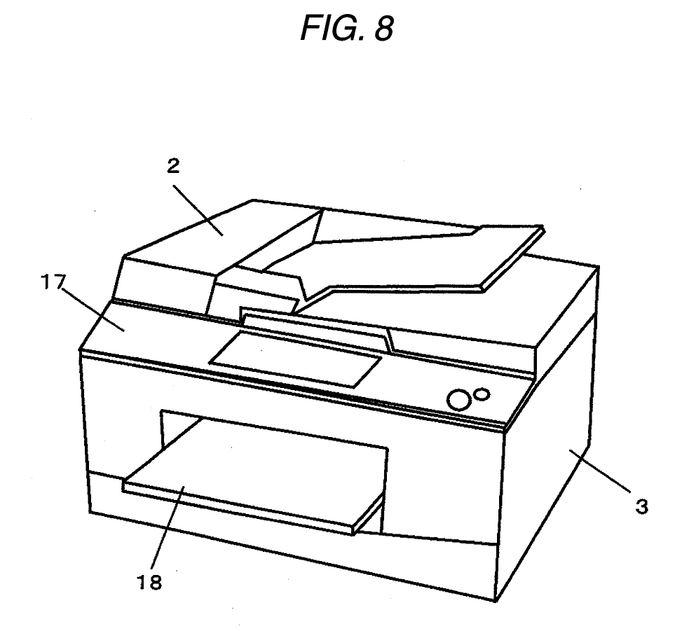

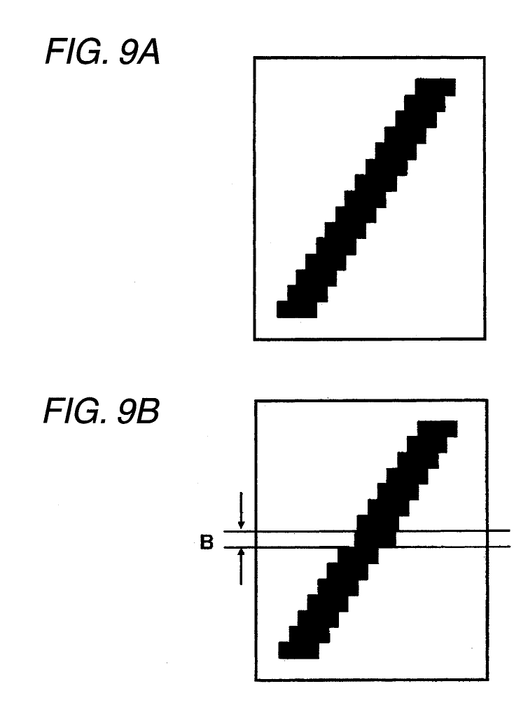

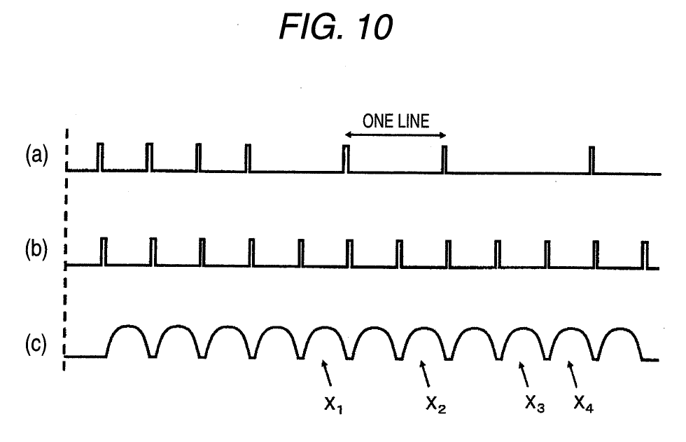

The invention can be applied to a copier including an image reading apparatus as shown in FIG. 8 wherein an automatic feeder 2 is placed on the top of a main unit 3 and the main unit 3 is provided with an operation section 17, a paper eject port 18, and the like.

This application is based upon and claims the benefit of priority of Japanese Patent Application No 2007-30020 filed on Feb. 9, 2007, the contents of which is incorporated herein by references in its entirety.

What is claimed is:

1. An image reading apparatus, comprising:
a roller which transports a sheet;
a motor which drives the roller;
an image sensor which reads data from the sheet; and
a control unit which synchronizes a read timing of the image sensor with a drive timing of the motor in response to change in the drive timing of the motor.

2. The image reading apparatus as claimed in claim 1, further comprising a storage unit which stores the data read by the image sensor,
wherein when a data storing capacity of the storage unit reaches a setup amount, transporting the sheet is temporarily stopped.

3. The image reading apparatus as claimed in claim 1, further comprising a conversion unit which converts a signal level of the data read by the image sensor in response to change in a transport speed of the sheet based on the change in the drive timing of the motor.

4. The image reading apparatus as claimed in claim 3, wherein when decreasing the transport speed from a reference transport speed, the conversion unit converts the signal level of the data read by the image sensor during decreasing the transport speed into a reference signal level of the data read at the reference transport speed.

5. The image reading apparatus as claimed in claim 3, wherein when increasing the transport speed to restore the transport speed to a reference transport speed, the conversion unit converts the signal level of the data read by the image sensor during increasing the transport speed into a reference signal level of the data read at the reference transport speed.

6. The image reading apparatus as claimed in claim 4, wherein a gain for converting the signal level depending on an exposure time of the image sensor when reading the data from the sheet during decreasing the transport speed is stored; and
wherein the conversion unit converts the signal level of the data read during decreasing the transport speed into the reference signal by using the gain.

7. The image reading apparatus as claimed in claim 5, wherein a gain for converting the signal level depending on an exposure time of the image sensor when reading the data from the sheet during increasing the transport speed is stored; and
wherein the conversion unit converts the signal level of the data read during increasing the transport speed into the reference signal level by using the gain.

8. The image reading apparatus as claimed in claim 4, wherein a gain is calculated according to a difference between a first exposure time based on a first transport speed and a second exposure time based on a second transport speed; and
wherein the conversion unit lowers the signal level of the data read during decreasing the transport speed to the reference signal level by multiplying the data read during decreasing the transport speed by the gain.

9. The image reading apparatus as claimed in claim 5, wherein a gain is calculated according to a difference between a first exposure time based on a first transport speed and a second exposure time based on a second transport speed; and
wherein the conversion unit lowers the signal level of the data read during increasing the transport speed to the reference signal level by multiplying the data read during increasing the transport speed by the gain.

10. The image reading apparatus as claimed in claim 8, wherein a comparison is made between the first exposure time when reading the data at the first transport speed and the second exposure time when reading the data at immediately preceding the first transport speed so as to calculate the gain based on a gain of the immediately preceding the first transport speed.

11. The image reading apparatus as claimed in claim 9, wherein a comparison is made between the first exposure time when reading the data at the first transport speed and the second exposure time when reading the data at immediately preceding the first transport speed so as to calculate the gain based on a gain on the immediately preceding the first transport speed.

12. The image reading apparatus as claimed in claim 8, wherein a comparison is made between the first exposure time when reading the data at the first transport speed and the second exposure time when reading the data at the reference transport speed so as to calculate the gain based on a gain on the reference transport speed.

13. The image reading apparatus as claimed in claim 9, wherein a comparison is made between the first exposure time when reading the data at the first transport speed and the second exposure time when reading the data at the reference transport speed so as to calculate the gain based on a gain on the reference transport speed.

14. The image reading apparatus as claimed in claim 4, wherein a plurality of gains corresponding to the respective transport speed is stored in a table; and
wherein the conversion unit multiplies the data read during decreasing the transport speed by the gain stored in the table to lower the signal level of the data to the reference signal level.

15. The image reading apparatus as claimed in claim 5, wherein a plurality of gains corresponding to the respective transport speed is stored in a table; and
wherein the conversion unit multiplies the data read during increasing the transport speed by the gain stored in the table to lower the signal level of the data to the reference signal level.

16. The image reading apparatus as claimed in claim 1, wherein the gain is determined at the timing just before start of reading the data by the image sensor.

17. The image reading apparatus as claimed in claim 1, wherein the motor is a stepping motor.

18. The image reading apparatus as claimed in claim 3, wherein an amplifier is used as the conversion unit.

19. The image reading apparatus as claimed in claim 18, wherein an amplification factor of the amplifier is calculated in response to change in the transport speed of the sheet.

20. The image reading apparatus as claimed in claim 18, wherein a plurality of amplification factors corresponding to a plurality of the transport speed is stored in a table and one of the amplification factors stored in the table is fetched in response to the transport speed.

21. The image reading apparatus as claimed in claim 18, wherein the signal level of the data read by the image sensor during decreasing the transport speed is converted into the reference signal level of the data read at the reference transport speed by using the amplifier.

22. The image reading apparatus as claimed in claim 18, wherein the signal level of the data read by the image sensor during increasing the transport speed is converted into the reference signal level of the data read at the reference transport speed by using the amplifier.

23. A copying machine comprising the image reading apparatus as claimed in claim 1.
